(19) United States
(12) Patent Application Publication
(10) Pub. No.: US 2019/0007223 A1
(43) Pub. Date: Jan. 3, 2019

(54) TECHNIQUES TO POWER ENCRYPTION CIRCUITRY

(71) Applicant: INTEL CORPORATION, SANTA CLARA, CA (US)

(72) Inventors: VAIBHAV VAIDYA, PORTLAND, OR (US); SANU K. MATHEW, HILLSBORO, OR (US); SUDHIR K. SATPATHY, HILLSBORO, OR (US); RAGHAVAN KUMAR, HILLSBORO, OR (US)

(73) Assignee: INTEL CORPORATION, SANTA CLARA, CA (US)

(21) Appl. No.: 15/640,469

(22) Filed: Jul. 1, 2017

(51) Int. Cl. H04L 9/38; H04L 9/06

(52) U.S. Cl. CPC H04L 9/38; H04L 9/005; H04L 9/0631

(57) ABSTRACT

Various embodiments are generally directed to techniques to power encryption circuitry, such as with a power converter, for instance. Some embodiments are particularly directed to a power converter that utilizes one or more capacitors to power encryption circuitry while masking the power signature of the encryption circuitry. In one or more embodiments, for example, a power converter may charge a capacitor with a power source of a computing platform, and then power encryption circuitry with the capacitor to perform a first portion of an encryption operation. In one or more such embodiments, the power converter may recharge the capacitor with the power source after completion of the first portion of the encryption operation, and perform a second portion of the encryption operation.

### BACKGROUND

Encryption/decryption circuitry may be used to enable the secure exchange of data. Typically, encryption circuitry may utilize a private key to convert a block of plaintext into a block of ciphertext, and decryption circuitry may utilize the private key to convert a block of ciphertext into a block of plaintext. Sometimes the encryption/decryption circuitry may be collectively referred to as encryption circuitry. Generally, the security of the encryption and decryption operations performed by the encryption circuitry depends on keeping the private key secret. For instance, encryption circuitry may mix the secret key with a block of plaintext to generate a corresponding block of ciphertext. In such instances, in the absence of any knowledge of the secret key, a malicious attack cannot obtain any information about the block of plaintext from the corresponding block of ciphertext. In various embodiments, encryption circuitry may be utilized by a computing platform for the secure exchange of data. In various such embodiments, the encryption circuitry may be power by a power source used to supply power to the computing platform.

### BRIEF DESCRIPTION OF THE DRAWINGS

FIG. 1 illustrates an embodiment of a first operating environment.

FIGS. 2A-2B illustrate embodiments of a second operating environment.

FIGS. 3A-3B illustrate embodiments of a third operating environment.

FIG. 4 illustrates an embodiment of a first logic flow.

FIG. 5 illustrates an embodiment of a storage medium.

FIG. 6 illustrates an embodiment of a computing architecture.

FIG. 7 illustrates an embodiment of a communications architecture.

### DETAILED DESCRIPTION

Various embodiments are generally directed to techniques to power encryption circuitry, such as with a power converter, for instance. Some embodiments are particularly directed to a power converter that utilizes one or more capacitors to power encryption circuitry while masking the power signature of the encryption circuitry. In one or more embodiments, for example, a power converter may charge a capacitor with a power source of a computing platform, and then power encryption circuitry with the capacitor to perform a first portion of an encryption operation. In one or more such embodiments, the power converter may recharge the capacitor with the power source after completion of the first portion of the encryption operation. In some embodiments, the power converter may pause the encryption operation as the capacitor is recharged. In some such embodiments, the power converter may power the encryption circuitry with the capacitor to perform a second portion of the encryption operation after the capacitor has been recharged. In other embodiments, the power converter may charge a second capacitor as the capacitor is used to power the encryption circuitry to perform the first portion of the encryption operation. In other such embodiments, the power converter may power the encryption circuitry with the second capacitor to perform a second portion of the encryption operation as the capacitor is recharged. These and other embodiments are described and claimed.

Some challenges facing encryption circuitry includes unsecure and/or inefficient techniques for powering the encryption circuitry. These challenges may result from the ability to use side channel attacks to determine a key used by the encryption circuitry. Once the key is known, any messages encrypted by the encryption circuitry may be decrypted and read by the possessor of the key. For instance, an advanced encryption standard (AES) key for a computing platform may be determined based on power and/or radio frequency (RF) measurements performed on encryption circuitry while the encryption circuitry is put in a loop performing repeated encryptions. In some such instances, a series resistance may be placed in the input power path to probe the power consumption of the encryption circuitry, and the key may be determined based on the power consumption. Also, the key may be hardwired into a computing platform, preventing or obstructing replacement of a compromised key with a new key. Adding further complexity, masking the power signature of encryption circuitry can lead to several inefficiencies. For example, creating a complementary power path that makes the power signature of the encryption circuitry independent of the key can require twice the encryption circuitry and twice the power. In another example, using power gating to mask the power signature can reduce the throughput by half. These and other factors may result in encryption circuitry with vulnerabilities, inefficiencies, and/or poor performance. Such limitations can drastically reduce the capabilities, usability, and applicability of the encryption circuitry, contributing to inefficient systems with available attack vectors.

Various embodiments described herein include a power converter that utilizes one or more capacitors to power encryption circuitry while encryption is being performed. In some embodiments, each of the one or more capacitors may always be charged/discharged to the same upper/lower voltage levels to prevent a power signature from being detectable. In various embodiments, the voltage output to the encryption circuitry by the power converter may be varied to further randomize the power signature of the encryption circuitry. In one or more embodiments, the one or more capacitors may be on-die capacitors. In one or more such embodiments, on-die capacitors may be more inefficient by being smaller and able to charge/discharge through a higher voltage swing. In some embodiments, the power converter may be an inductor or inductor-capacitor based power converter. In embodiments with multiple capacitors, each capacitor may be discharged to a known minimum voltage as one or more other capacitors are charged. In such embodiments, this may enable the encryption circuitry to be continuously powered. Further, charging other capacitors as one is being discharged may sum their energies in one or more inductors, thereby obfuscating the energy consumed by the encryption circuitry. In one or more embodiments, magnetic shielding may be utilized for the inductors to minimize fringing fields. In some embodiments, the number of rounds powered by a capacitor may be held constant to achieve the best protections. In other embodiments, the power converter may automatically adapt to the energy consumed to achieve the best efficiencies. In other such embodiments, although some power information may be leaked to the input, it will be highly quantized by the number of encryption rounds, thereby making side channel attacks extremely difficult and impractical. In these and other ways the power converter may power encryption circuitry in a secure and efficient manner to achieve improved encryption techniques with increased throughput, reduced cell area, and improved security, resulting in several technical effects and advantages.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

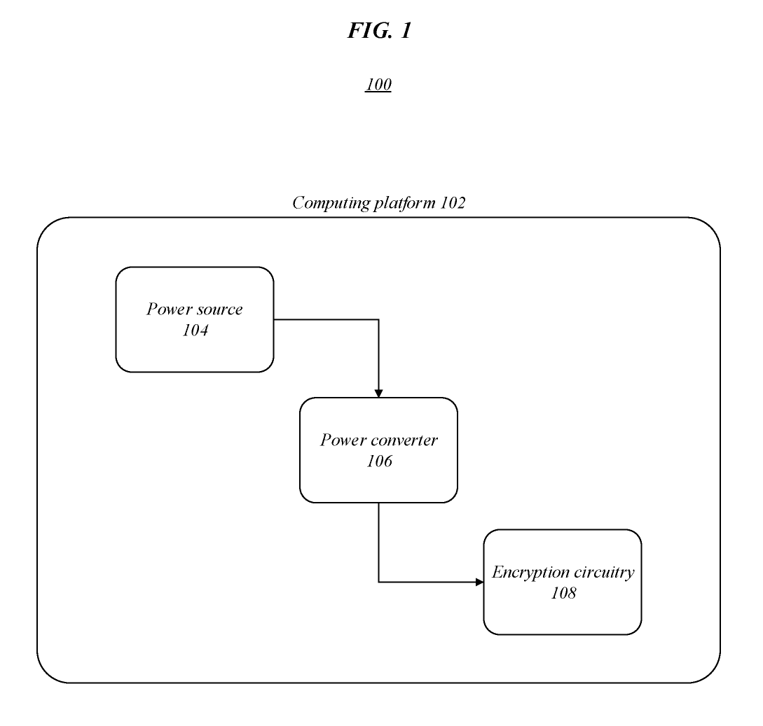

FIG. 1 illustrates an embodiment of an operating environment that may be representative of various embodiments. Operating environment 100 may include computing platform 102 with power source 104, power converter 106, and encryption circuitry 108. In one or more embodiments described here, power converter 106 may mask a power signature of encryption circuitry 108. In one or more such embodiments, power converter 106 may utilize one or more capacitors to mask the power signature of encryption circuitry 108. For instance, power converter may power encryption circuitry 108 with one or more capacitors while encryption is being performed. In some such instances, the one or more capacitors may be charged with power source 104. In some embodiments, power converter 106 may include an inductor-capacitor based power converter. Embodiments are not limited in this context.

In various embodiments, power converter 106 may store, or cause to be stored, energy from power source 104. In various such embodiments, the stored energy may then be used to power encryption circuitry 108. For example, power converter 106 may include an inductor based power converter on-die that uses either one or two on-die storage capacitors to supply power to encryption circuitry. In one or more embodiments, on-die capacitors may provide space savings (e.g., reduced cell area) and utilize a higher voltage swing between charged and discharged states. In some embodiments, the one or more capacitors may be charged/discharged between the same two voltage levels to prevent a power signature from escaping the chip. In one or more embodiments, power converter 106 may eliminate the ability to perform an external power probe side channel attack by drawing all power for encryption circuitry 108 from the one or more storage capacitors. In various embodiments, power converter 108 may include or utilize one or more of a buck converter, a boost converter, or a buck-boost converter.

In embodiments with multiple capacitors, each capacitor may be discharged/charged alternatively while continuously running encryption circuitry 108. In embodiments with a single capacitor, encryption may be paused as the capacitor is charged/recharged and then resumed once the capacitor is charged/recharged. In various embodiments, encryption circuitry 108 may perform one or more rounds of encryption, such as in a block cipher mode of operation. In various such embodiments, the number of rounds powered by each capacitor (e.g., during a discharge cycle) may be held constant. In other such embodiments, the number of rounds powered by each capacitor may be automatically adapted by power converter 106 based on the energy consumed.

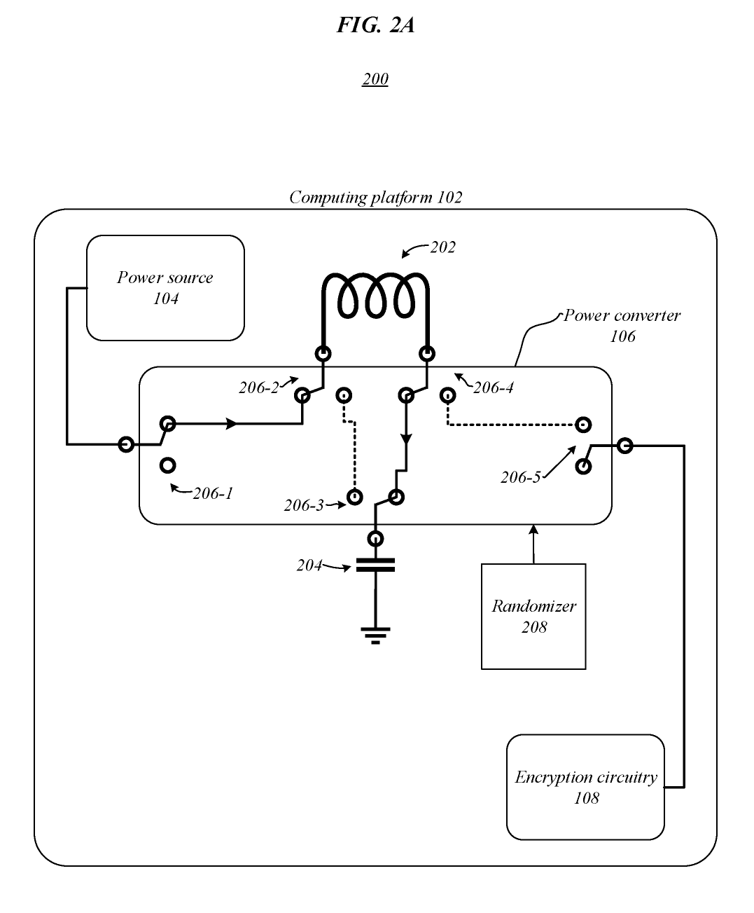

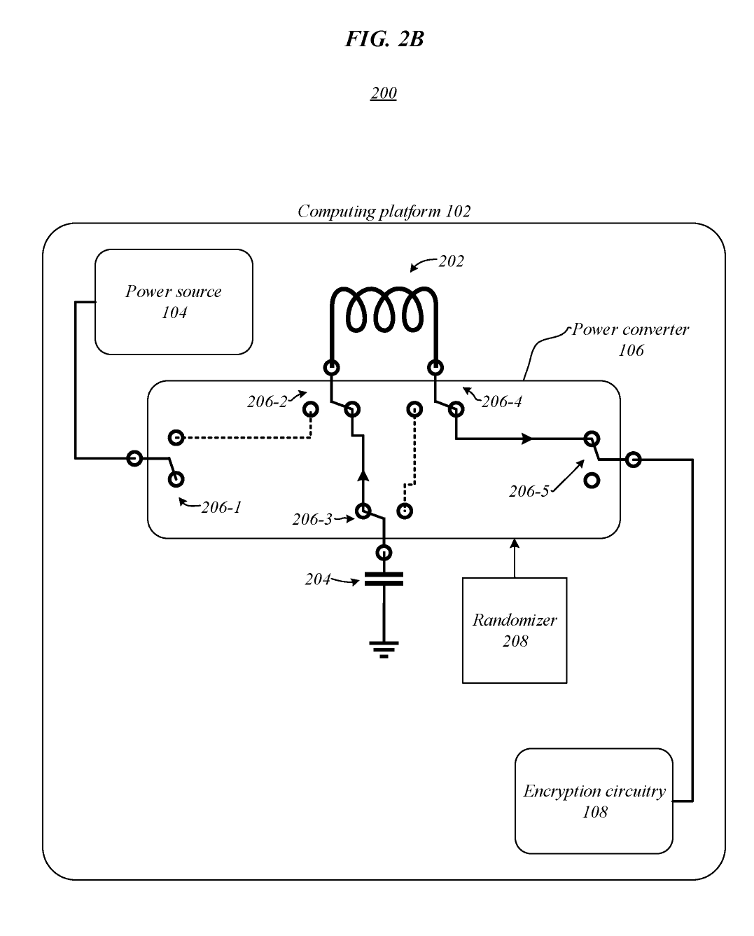

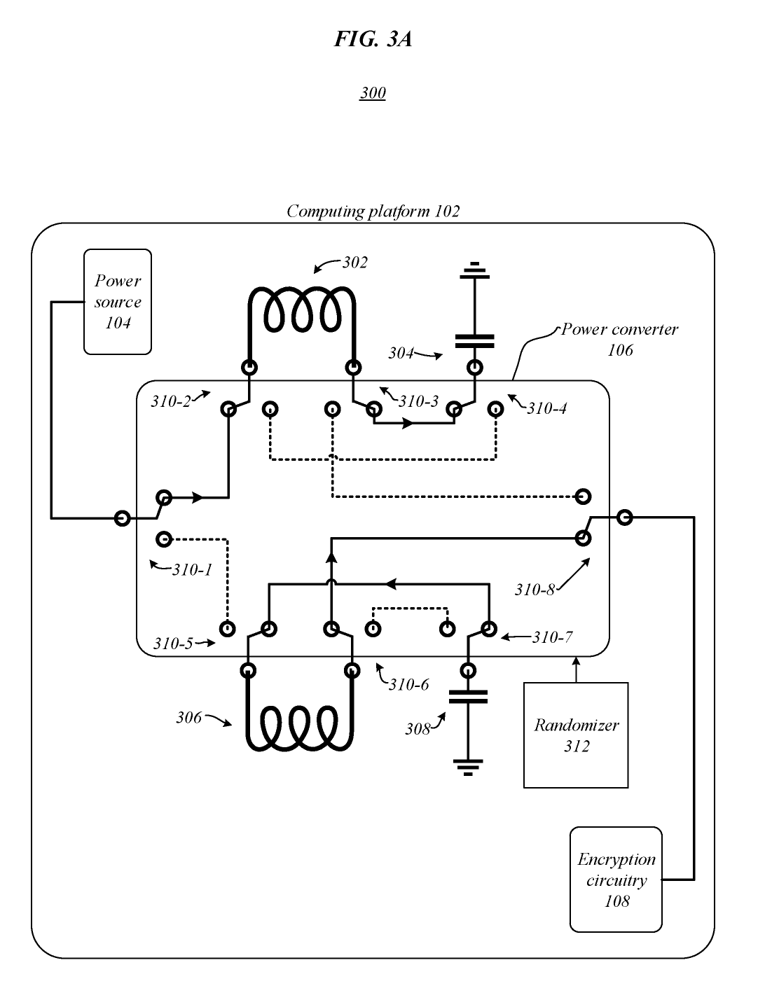

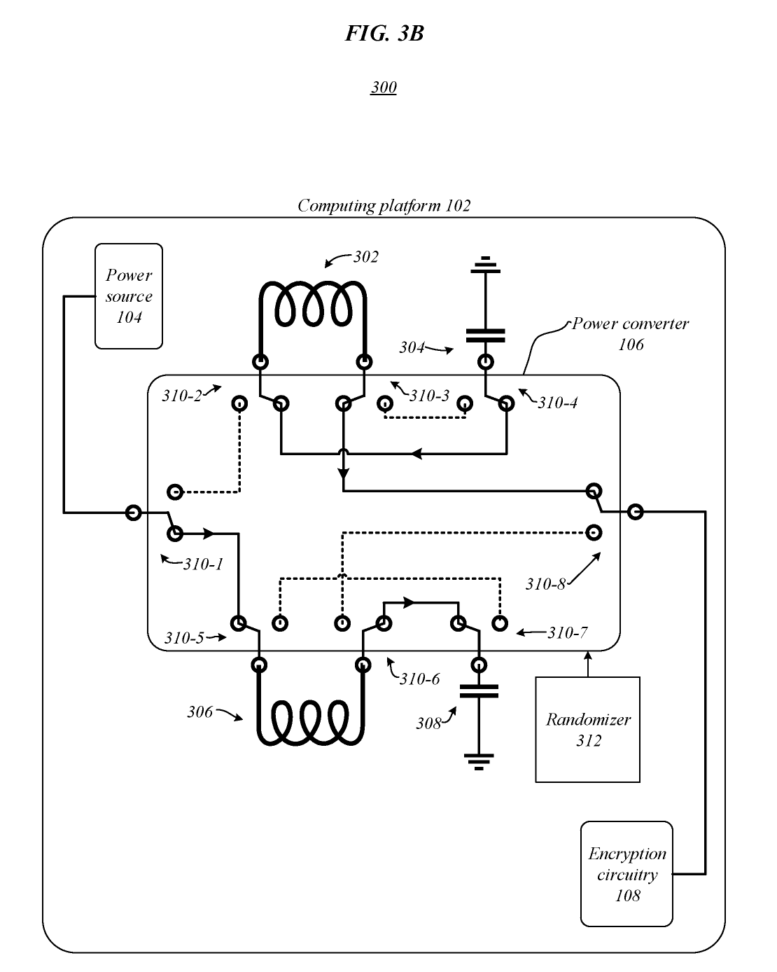

In some embodiments, power source 104 may be used by power converter 106 to charge the one or more capacitors. In some such embodiments, power converter 106 may operate one or more switches to conductively couple each capacitor to either the power source 104 or the encryption circuitry 108. This aspect will be described in more detail below, such as with respect to FIGS. 2A-3B. In one or more embodiments, power source 104 may be a power supply rail of computing platform 102. In various embodiments, power source 104 may provide power to one or more other components of computing platform 102. In some embodiments, power source 104 may provide power to one or more power domains of computing platform 102. In one or more embodiments, power source 104 may provide a constant voltage to power converter 106.

In one or more embodiments, encryption circuitry 108 may provide an information service to computing platform 102, such as confidentiality or authenticity. Accordingly, encryption circuitry 108 may perform one or more encryption operations for computing platform 102 as part of the information service. As used herein, an encryption operation may include one or more of encryption or decryption. In some embodiments, encryption circuitry 108 may include one or more block ciphers. In some such embodiments, encryption circuitry 108 may utilize a block cipher mode of operation. In various embodiments, a block cipher may be used to perform a secure cryptographic transformation on a fixed-length group of bits referred to as a block. In various such embodiments, a mode of operation may describe how to repeatedly apply the cipher block to securely transform amounts of data larger than a block. In some embodiments, the mode of operation of encryption circuitry 108 may include one or more of electronic codebook (ECB), cipher block chaining (CBC), propagating CBC, cipher feedback (CFB), output feedback (OFB), or counter (CTR). In one or more embodiments, encryption circuitry 108 may include digital circuitry.

FIGS. 2A-2B illustrate embodiments of a second operating environment 200. Operating environment 200 may include an embodiment of power converter 106 that utilizes an inductor 202, and a capacitor 204. FIG. 2A may illustrate a state of power converter 106 in which capacitor 204 is being charged with power source 104. FIG. 2B may illustrate a state of power converter 106 in which capacitor 204 is being used to power encryption circuitry 108. In operating environment 200, power converter 106 may include a set of switches 206-1, 206-2, 206-3, 206-4, 206-5 (i.e., set of switches 206) that can be operated to alternatively charge and discharge capacitor 204. In various embodiments, randomizer 208 may be utilized by power converter 106 to vary the voltage output to encryption circuitry 108. Embodiments are not limited in this context.

In one or more embodiments described herein, performance of an encryption operation within operating environment 200 may proceed as follows. Capacitor 204 may be charged to an upper voltage, Vᵤₚₚₑᵣ. For example, the upper voltage may be 1.5 volts. However, it will be appreciated that the higher voltage may be any voltage that can be safely handled by power converter 106, capacitor 204, and/or inductor 202. Further, the higher voltage may be stepped down before being provided to encryption circuitry 108. In some embodiments capacitor 204 may be on-die. In other words, capacitor 204 may be on the same chip (e.g., wafer of silicon) as one or more other components of computing platform 102, such as a central processing unit (CPU). Once capacitor 204 is charged, it may be conductively disconnected from power source 104 and conductively connected to encryption circuitry 108. For instance, and as will be described in more detail below, one or more of switches 206-1, 206-2, 206-3, 206-4, 206-5 may be operated to conductively disconnect capacitor 204 from power source 104 and conductively connect capacitor 204 to encryption circuitry 108. In various embodiments, a decoupling capacitor may be positioned between inductor 202 and encryption circuitry 108. In various such embodiments, the decoupling capacitor may decouple power converter 106 from encryption circuitry 108. In some embodiments, encryption circuitry 108 may be a voltage-input circuit. In some such embodiments, the decoupling capacitor may prevent inductor 202 from acting like a current source, enabling proper operation of encryption circuitry 108.

In various embodiments, each of switches 206-1, 206-2, 206-3, 206-4, 206-5 may include any type of device that is able to reversibly alter or terminate a conductive pathway, such as a transistor, microelectromechanical system (MEMS), nanoelectromechanical system (NEMS), or the like. For example, switch 206-1 may reversibly terminate a conductive pathway between power source 104 and switch 206-2. In another example, switch 206-2 may reversibly alter a conductive pathway from between inductor 202 and switch 206-1 to between inductor 202 and switch 206-3. It will be appreciated that more or less switches may be used without departing from the scope of this disclosure. For instance, switch 206-1 may not be included such that switch 206-2 reversibly alters a conductive pathway from between power source 104 and inductor 202 to between switch 206-3 and inductor 202.

Once capacitor 204 is conductively connected to encryption circuit 108, it may be depleted to a lower voltage, V_{lower}, such as by powering encryption circuitry 108 to perform one or more portions of an encryption operation for computing platform 102. For instance, the lower voltage may be 0.5 volts. In some embodiments, the energy in capacitor 204 may be depleted in terms of ½C(Vᵤₚₚₑᵣ²−V_{lower}²), where C is the capacitance of capacitor 204. In some embodiments, the capacitance of capacitor 204 may be in the order of nano-farads. In one or more embodiments, capacitor 204 may not be discharged to the lower voltage after being used to power encryption circuitry 108 to perform one or more portions of an encryption operation. In one or more such embodiments, power converter 106 may deplete capacitor 204 to the lower voltage by discharging energy stored by capacitor 204 to ground. For instance, if the same number of rounds are always performed during a discharge cycle, and the leftover power is dissipated to ground, the relationship between input power and encryption rounds will be constant. In some such instances, this may prevent power attacks entirely.

Once capacitor 204 is discharged to the lower voltage, it may be conductively disconnected from encryption circuitry 108 and conductively connected to power source 104 to be recharged to the upper voltage level. In various embodiments, as capacitor 204 is charged/recharged, encryption operations performed by encryption circuitry 108 may be paused. This cycle of charging/discharging capacitor 204 may be repeated until the encryption operation is completed.

Referring specifically to FIG. 2A, the charging of capacitor 204 will now be described in more detail. Power converter 106 may charge or recharge capacitor 204, such as to an upper voltage, with power source 104 of computing platform 102 by operating one or more of switches 206-1, 206-2, 206-3, 206-4, 206-5 such that current passes from power source 104 into inductor 202 and then into capacitor 204. For instance, switch 206-1 may be operated to establish a conductive pathway between power source 104 and switch 206-2, switch 206-2 may be operated to establish a conductive pathway between switch 206-1 and inductor 202, switch 206-4 may be operated to establish a conductive pathway between inductor 202 and switch 206-3, and switch 206-3 may be operated to establish a conductive pathway between switch 206-4 and capacitor 204. In various embodiments, switch 206-5 may be operated to terminate a conductive pathway between switch 206-4 and encryption circuitry 108. Accordingly, power converter 106 may conductively connect power source 104 to capacitor 204, thereby enabling capacitor 204 to draw an electrical current from power source 104 via inductor 202 to charge the capacitor 204. In some embodiments power converter 106 may include one or more sensors to measure the charge of capacitor 204, either directly or indirectly. Once capacitor 204 is charged, such as to the upper voltage level, power converter 106 may power encryption circuitry 108 by discharging capacitor 204.

Referring specifically to FIG. 2B, the discharging of capacitor 204 will now be described in more detail. Power converter 106 may discharge capacitor 204, such as to a lower voltage, by powering encryption circuitry 108 to perform one or more portions of an encryption operation for computing platform 102 with capacitor 204. In some embodiments, power converter 106 may power encryption circuitry 108 with capacitor 204 by operating one or more of switches 206-1, 206-2, 206-3, 206-4, 206-5 such that current passes from capacitor 204 into inductor 202 and then into encryption circuitry 108. For instance, switch 206-3 may be operated to establish a conductive pathway between capacitor 204 and switch 206-2, switch 206-2 may be operated to establish a conductive pathway between switch 206-3 and inductor 202, switch 206-4 may be operated to establish a conductive pathway between inductor 202 and switch 206-5, and switch 206-5 may be operated to establish a conductive pathway between switch 206-4 and encryption circuitry 108. In various embodiments, switch 206-1 may be operated to terminate a conductive pathway between power source 104 and switch 206-2. Accordingly, power converter 106 may conductively connect capacitor 204 to encryption circuitry 108, thereby enabling encryption circuitry 108 to draw an electrical current from capacitor 204 via inductor 202 to perform an encryption operation and discharge capacitor 204. In some embodiments power converter 106 may include one or more sensors to measure the charge of capacitor 204, either directly or indirectly. Once capacitor 204 is discharged, such as to the lower voltage level, power converter 106 may recharge capacitor 204 with power source 104.

In various embodiments, the voltage level provided to encryption circuitry 108 may be varied with randomizer 208. In various such embodiments, this may further randomize the power signature of encryption circuitry 108. For instance, the power of a digital circuit, such as encryption circuitry 108 may scale with the square of its supply voltage. Further, the circuit can meet timing as long as its supply voltage is above a minimum allowable voltage. Thus, if the supply voltage is increased by 5% above the minimum allowable voltage, the circuit power will increase by roughly 10%. Accordingly, with randomizer 208, the power signature may be further randomized while ensuring that the encryption occurs reliably. In some embodiments, this randomization may be 1.05V±50 mV.

In some embodiments, this voltage randomization may mitigate the threat of using radio frequency (RF) probing to crack a key used by encryption circuitry 108. For instance, inductor 202 may radiate energy that could be probed to sample the power consumption of encryption circuitry 108 and perform a side channel attack. In one or more embodiments, randomizer 208 may include a voltage regulator. In one or more such embodiments, the voltage regulator may be digitally controlled, such as by one or more components of computing platform 102. In various embodiments, magnetic shielding may additionally or alternatively be used to mitigate the threat of RF probing by limiting the amount of energy radiated by inductor 202.

FIGS. 3A-3B illustrate embodiments of a third operating environment 300. Operating environment 300 may include an embodiment of power converter 106 that utilizes first and second inductors 302, 306, and first and second capacitors 304, 308. In some embodiments, one or more of inductors 302, 306 may be the same or similar to inductor 202 and one or more of capacitors 304, 308 may be the same or similar to capacitor 204. FIG. 3A may illustrate a state of power converter 106 in which capacitor 304 is being charged with power source 104 while capacitor 308 is being used to power encryption circuitry 108. FIG. 3B may illustrate a state of power converter 106 in which capacitor 304 is being used to power encryption circuitry 108 while capacitor 308 is being charged with power source 104. In operating environment 300, power converter 106 may include a set of switches 310-1, 310-2, 310-3, 310-4, 310-5, 310-6, 310-7, 310-8 (i.e., set of switches 310) that can be operated to alternatively charge capacitor 304 as capacitor 308 is being discharged and discharge capacitor 304 as capacitor 308 is being charged. In various embodiments, randomizer 312 may be utilized by power converter 106 to vary the voltage output to encryption circuitry 108. In some embodiments randomizer 312 may be the same or similar to randomizer 208. Embodiments are not limited in this context.

In one or more embodiments described herein, performance of an encryption operation within operating environment 300 may proceed as follows. Capacitor 304 may be charged to a first upper voltage, V_{1,upper}. For example, the first upper voltage may be 1.5 volts. However, it will be appreciated that the first higher voltage may be any voltage that can be safely handled by power converter 106, capacitor 304, and/or inductor 302. Further, the first higher voltage may be stepped down before being provided to encryption circuitry 108. In some embodiments capacitor 304 may be on-die. In other words, capacitor 304 may be on the same chip (e.g., wafer of silicon) as one or more other components of computing platform 102, such as a central processing unit (CPU).

As capacitor 304 is charged, conductor 308 may be depleted from a second upper voltage, V_{2,upper}, to a second lower voltage, V_{2,lower}, such as by powering encryption circuitry 108 to perform a first portion of an encryption operation for computing platform 102. For instance, the lower voltage may be 0.5 volts. In some embodiments, the energy in capacitor 308 may be depleted in terms of ½C₂(V_{2,upper}²−V_{2,lower}²), where C₂ is the capacitance of capacitor 308. In some embodiments, the capacitance of capacitor 308 may be in the order of nano-farads. In one or more embodiments, capacitor 308 may not be discharged to the second lower voltage after being used to power encryption circuitry 108 to perform the portion of the encryption operation. In one or more such embodiments, power converter 106 may deplete capacitor 308 to the second lower voltage by discharging energy stored by capacitor 308 to ground. For instance, if the same number of rounds are always performed during a discharge cycle, and the leftover power is dissipated to ground, the relationship between input power and encryption rounds will be constant. In some such instances, this may prevent power attacks entirely.

Once capacitor 308 is discharged and capacitor 304 is charged, capacitor 308 may be conductively disconnected from encryption circuitry 108 and conductively connected to power source 104 and capacitor 304 may be conductively disconnected from power source 104 and conductively connected to encryption circuitry 108. For instance, and as will be described in more detail below, one or more switches in the set of switches 310 may be operated to conductively disconnect capacitor 308 from encryption circuitry 108, conductively disconnect capacitor 304 from power source 104, conductively connect capacitor 308 to power source 104, and conductively connect capacitor 304 to encryption circuitry 108. In some embodiments, capacitor 386 may be split off from capacitor 304. In some such embodiments, this may prevent the overall area from growing when two capacitors are used as opposed to one.

In various embodiments, a first decoupling capacitor may be positioned between inductor 302 and encryption circuitry 108 and a second decoupling capacitor may be positioned between inductor 306. In various such embodiments, the first and second decoupling capacitors may be the same decoupling capacitor. In one or more embodiments, the decoupling capacitor may decouple power converter 106 from encryption circuitry 108. In some embodiments, encryption circuitry 108 may be a voltage-input circuit. In some such embodiments, the decoupling capacitor may prevent inductors 302, 306 from acting like a current source, enabling proper operation of encryption circuitry 108.

In one or more embodiments, inductors 302, 306 may be a common inductor. In one or more such embodiments, the common inductor may be used to power both of capacitors 304, 308. For instance, time multiplexing may be utilized to enable the common inductor to power both capacitors. In embodiments with a common inductor, the common inductor may have sufficient power transfer capacity to handle both charging of one capacitor while discharging the other capacitor to power encryption circuitry 108. For example, if encryption circuitry 108 consumes 100 mA, but the common inductor peak current is 400 mA (i.e., average current of 200 mA), the common inductor can charge one capacitor with 100 mA average and supply encryption circuitry 108 with 100 mA average from the other capacitor. In such instances, this may be achieved with consecutive and repetitive current pulses. In embodiments that utilize a consecutive and repetitive current pulses, the decoupling capacitor(s) described above may maintain sufficient power supply to encryption circuitry 108 in between inductor pulses.

In various embodiments, each of switches 310-1, 310-2, 310-3, 310-4, 310-5, 310-6, 310-7, 310-8 may include any type of device that is able to reversibly alter or terminate a conductive pathway, such as a transistor, microelectromechanical system (MEMS), nanoelectromechanical system (NEMS), or the like. For example, switch 310-2 may reversibly alter a conductive pathway from between inductor 302 and switch 310-1 to between inductor 302 and switch 310-4. It will be appreciated that more or less switches may be used without departing from the scope of this disclosure.

Once capacitor 304 is conductively connected to encryption circuit 108, it may be depleted from the first upper voltage, V_{1,upper} to a first lower voltage, V_{1,lower}, such as by powering encryption circuitry 108 to perform a second portion of an encryption operation for computing platform 102. For instance, the first lower voltage may be 0.5 volts. In one or more embodiments, the first and second lower voltages may be equal. In some embodiments, the energy in capacitor 304 may be depleted in terms of ½C₁(V_{1,upper}²−V_{1,lower}²), where C₁ is the capacitance of capacitor 304. In some embodiments, the capacitance of capacitor 304 may be in the order of nano-farads. In one or more embodiments, capacitor 304 may not be discharged to the first lower voltage after being used to power encryption circuitry 108 to perform one or more portions of an encryption operation. In one or more such embodiments, power converter 106 may deplete capacitor 304 to the first lower voltage by discharging energy stored by capacitor 304 to ground. For instance, if the same number of rounds are always performed during a discharge cycle, and the leftover power is dissipated to ground, the relationship between input power and encryption rounds will be constant. In some such instances, this may prevent power attacks entirely.

As capacitor 304 is discharged, capacitor 308 may be charged or recharged to the second upper voltage, V_{2,upper}. Capacitor 308 may be charged to the second upper voltage, V_{2,upper}. For example, the second upper voltage may be 1.5 volts. However, it will be appreciated that the second higher voltage may be any voltage that can be safely handled by power converter 106, capacitor 308, and/or inductor 306. Further, the second higher voltage may be stepped down before being provided to encryption circuitry 108. In some embodiments capacitor 308 may be on-die. In other words, capacitor 308 may be on the same chip (e.g., wafer of silicon) as one or more other components of computing platform 102, such as a central processing unit (CPU). In various embodiments, the first and second upper voltages may be the same or different. In one or more embodiments, the first and second lower voltages may be the same or different. This cycle of alternately charging/discharging capacitors 304, 308 may be repeated until the encryption operation is completed.

Referring specifically to FIG. 3A, the charging of capacitor 304 and discharging of capacitor 308 will now be described in more detail. Power converter 106 may charge or recharge capacitor 304, such as to an upper voltage, with power source 104 of computing platform 102 by operating one or more of switches 310-1, 310-2, 310-3, and 310-4 such that current passes from power source 104 into inductor 302 and then into capacitor 304. For instance, switch 310-1 may be operated to establish a conductive pathway between power source 104 and switch 310-2, switch 310-2 may be operated to establish a conductive pathway between switch 310-1 and inductor 302, switch 310-3 may be operated to establish a conductive pathway between inductor 302 and switch 310-4, and switch 310-4 may be operated to establish a conductive pathway between switch 310-3 and capacitor 304. Accordingly, power converter 106 may conductively connect power source 104 to capacitor 304, thereby enabling capacitor 304 to draw an electrical current from power source 104 via inductor 302 to charge the capacitor 304. In some embodiments power converter 106 may include one or more sensors to measure the charge of capacitor 304, either directly or indirectly.

As capacitor 304 is being charged, power converter 106 may discharge capacitor 308, such as to a lower voltage, by powering encryption circuitry 108 to perform one or more portions of an encryption operation for computing platform 102 with capacitor 308. In some embodiments, power converter 106 may power encryption circuitry 108 with capacitor 308 by operating one or more of switches 310-5, 310-6, 310-7, and 310-8 such that current passes from capacitor 308 into inductor 306 and then into encryption circuitry 108. For instance, switch 310-7 may be operated to establish a conductive pathway between capacitor 308 and switch 310-5, switch 310-5 may be operated to establish a conductive pathway between switch 310-7 and inductor 306, switch 310-6 may be operated to establish a conductive pathway between inductor 306 and switch 310-8, and switch 310-8 may be operated to establish a conductive pathway between switch 310-6 and encryption circuitry 108. Accordingly, power converter 106 may conductively connect capacitor 308 to encryption circuitry 108, thereby enabling encryption circuitry 108 to draw an electrical current from capacitor 308 via inductor 306 to perform an encryption operation and discharge capacitor 308. In some embodiments power converter 106 may include one or more sensors to measure the charge of capacitor 308, either directly or indirectly. Once capacitor 308 is discharged, such as to the lower voltage level, power converter 106 may recharge capacitor 308 with power source 104 and power encryption circuitry 108 by discharging capacitor 304.

Referring specifically to FIG. 3B, the charging of capacitor 308 and discharging of capacitor 304 will now be described in more detail. Power converter 106 may charge or recharge capacitor 308, such as to an upper voltage, with power source 104 of computing platform 102 by operating one or more of switches 310-1, 310-5, 310-6, and 310-7 such that current passes from power source 104 into inductor 306 and then into capacitor 308. For instance, switch 310-1 may be operated to establish a conductive pathway between power source 104 and switch 310-5, switch 310-5 may be operated to establish a conductive pathway between switch 310-1 and inductor 306, switch 310-6 may be operated to establish a conductive pathway between inductor 306 and switch 310-7, and switch 310-7 may be operated to establish a conductive pathway between switch 310-7 and capacitor 308. Accordingly, power converter 106 may conductively connect power source 104 to capacitor 308, thereby enabling capacitor 308 to draw an electrical current from power source 104 via inductor 306 to charge the capacitor 308. In some embodiments power converter 106 may include one or more sensors to measure the charge of capacitor 308, either directly or indirectly.

As capacitor 308 is being charged, power converter 106 may discharge capacitor 304, such as to a lower voltage, by powering encryption circuitry 108 to perform one or more portions of an encryption operation for computing platform 102 with capacitor 304. In some embodiments, power converter 106 may power encryption circuitry 108 with capacitor 304 by operating one or more of switches 310-2, 310-3, 310-4, and 310-8 such that current passes from capacitor 304 into inductor 302 and then into encryption circuitry 108. For instance, switch 310-4 may be operated to establish a conductive pathway between capacitor 304 and switch 310-2, switch 310-2 may be operated to establish a conductive pathway between switch 310-4 and inductor 302, switch 310-3 may be operated to establish a conductive pathway between inductor 302 and switch 310-8, and switch 310-8 may be operated to establish a conductive pathway between switch 310-3 and encryption circuitry 108. Accordingly, power converter 106 may conductively connect capacitor 304 to encryption circuitry 108, thereby enabling encryption circuitry 108 to draw an electrical current from capacitor 304 via inductor 302 to perform an encryption operation and discharge capacitor 304. In some embodiments power converter 106 may include one or more sensors to measure the charge of capacitor 304, either directly or indirectly. Once capacitor 304 is discharged, such as to the lower voltage level, power converter 106 may recharge capacitor 304 with power source 104 and power encryption circuitry 108 by discharging capacitor 308.

In various embodiments, the voltage level provided to encryption circuitry 108 may be varied with randomizer 312. In various such embodiments, this may further randomize the power signature of encryption circuitry 108. For instance, the power of a digital circuit, such as encryption circuitry 108 may scale with the square of its supply voltage. Further, the circuit can meet timing as long as its supply voltage is above a minimum allowable voltage. Thus, if the supply voltage is increased by 5% above the minimum allowable voltage, the circuit power will increase by roughly 10%. Accordingly, with randomizer 312, the power signature may be further randomized while ensuring that the encryption occurs reliably. In some embodiments, this randomization may be 1.05V±50 mV.

In some embodiments, this voltage randomization may mitigate the threat of using radio frequency (RF) probing to crack a key used by encryption circuitry 108. For instance, inductors 302, 306 may radiate energy that could be probed to sample the power consumption of encryption circuitry 108 and perform a side channel attack. In one or more embodiments, randomizer 312 may include a voltage regulator. In one or more such embodiments, the voltage regulator may be digitally controlled, such as by one or more components of computing platform 102. In various embodiments, magnetic shielding may additionally or alternatively be used to mitigate the threat of RF probing by limiting the amount of energy radiated by inductors 302, 306. Further, in some embodiments, by charging one capacitor while another is being discharged may sum their energies in the inductors and obfuscate the energy consumed by encryption circuitry 108.

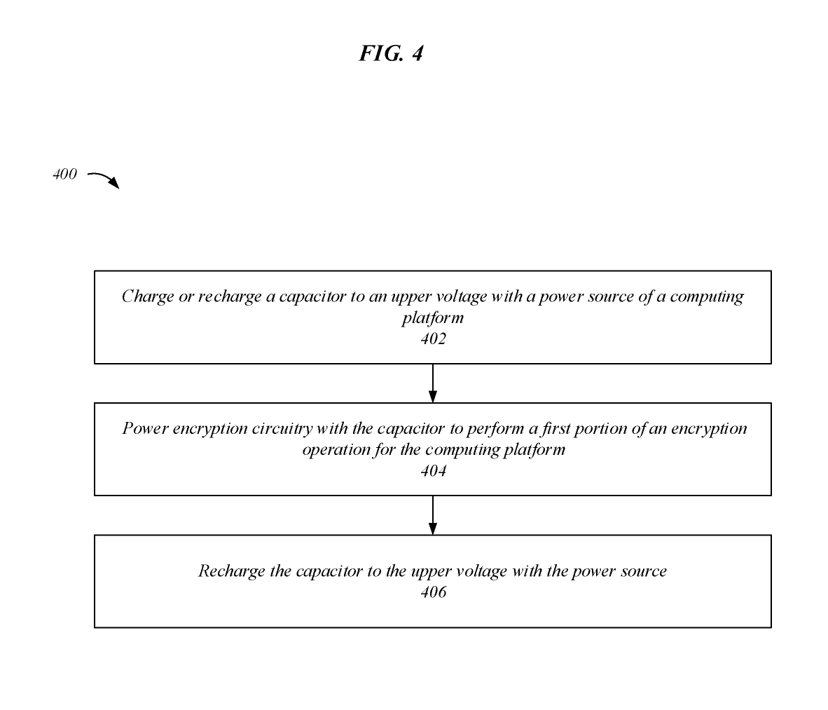

FIG. 4 illustrates one embodiment of a logic flow 400. The logic flow 400 may be representative of some or all of the operations executed by one or more embodiments described herein. Embodiments are not limited in this context.

In the illustrated embodiment shown in FIG. 4, the logic flow 400 may begin at block 402. At block 402 “charge or recharge a capacitor to an upper voltage with a power source of a computing platform” a capacitor may be charged or recharged to an upper voltage using a power source of a computing platform. For instance, capacitor 204 may be charged to an upper voltage with power source 104 of computing platform 102. In some embodiments, power converter 106 may charge or recharge one or more of capacitors 204, 304, 308 to an upper voltage with power source 104.

At block 404 “power encryption circuitry with the capacitor to perform a first portion of an encryption operation for the computing platform” encryption circuitry may be powered to perform a first portion of an encryption operation for the computing platform. For example, capacitor 204 may be used to power encryption circuitry 108 to perform a first portion of an encryption operation for computing platform 102. In various embodiments, one or more of capacitors 204, 304, 308 may be used to power encryption circuitry 108 to perform one or more portions of an encryption operation for computing platform 102. In various such embodiments, capacitor 304 may be used to power encryption circuitry 108 to perform a first portion of an encryption operation and capacitor 308 may be used to power encryption circuitry 108 to perform a second portion of the encryption operation.

Continuing to block 406 “recharge the capacitor to the upper voltage with the power source” the capacitor may be recharged to the upper voltage with the power source. For instance, capacitor 204 may be recharged to an upper voltage using power source 104 of computing platform 102. In some embodiments, capacitor 204 may be recharged to the upper voltage after being used to power encryption circuitry 108 to perform a first portion of an encryption operation. In some such embodiments, capacitor 204 may be used to power encryption circuitry 108 to perform a second portion of the encryption operation after being recharged. In one or more embodiments, the encryption operation may be paused as the capacitor is recharged (e.g., capacitor 204). In other embodiments, another capacitor (e.g., capacitor 308) may be used to power encryption circuitry 108 to perform another portion of the encryption operation while the capacitor (e.g., capacitor 304) is being recharged.

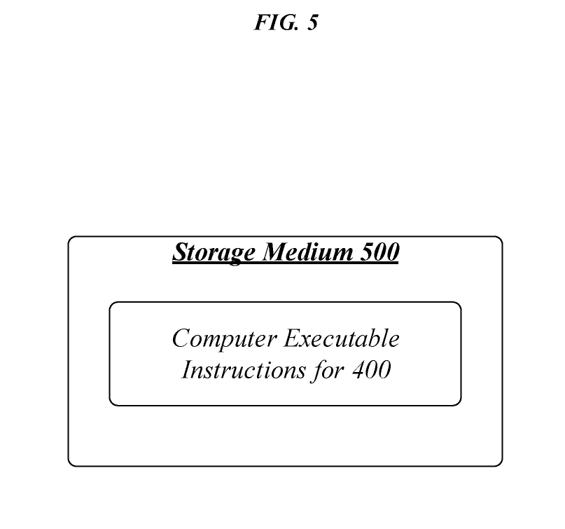

FIG. 5 illustrates an embodiment of a storage medium 500. Storage medium 500 may comprise any non-transitory computer-readable storage medium or machine-readable storage medium, such as an optical, magnetic or semiconductor storage medium. In various embodiments, storage medium 500 may comprise an article of manufacture. In some embodiments, storage medium 500 may store computer-executable instructions, such as computer-executable instructions to implement one or more of logic flows or operations described herein, such as with respect to 400 of FIG. 4. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

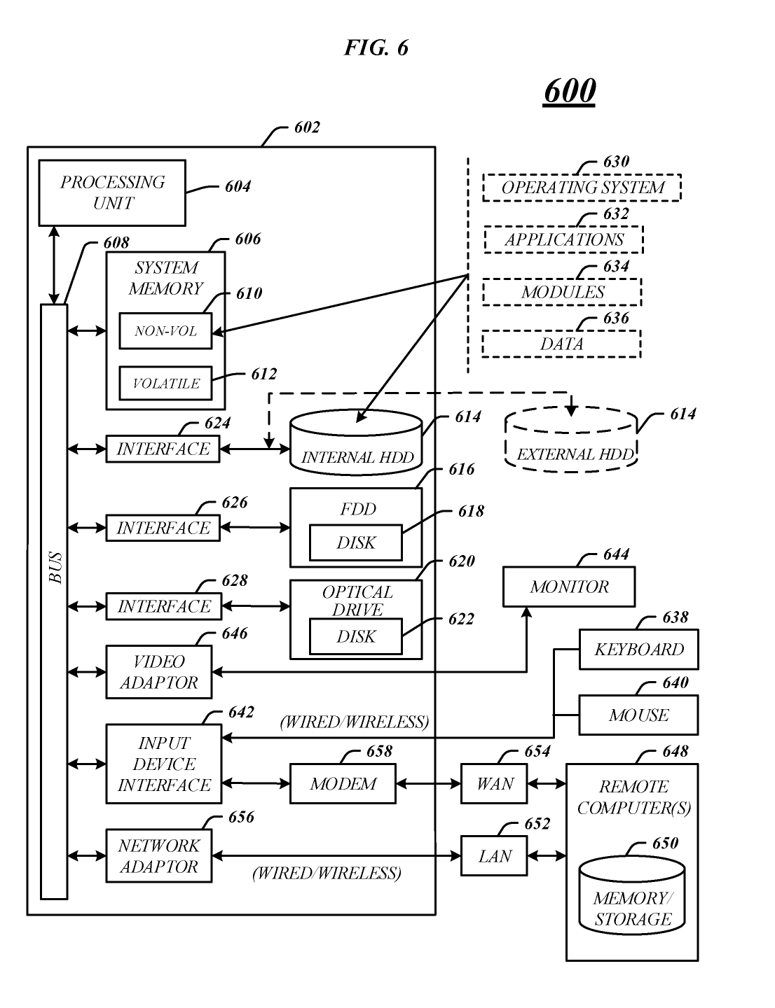

FIG. 6 illustrates an embodiment of an exemplary computing architecture 600 that may be suitable for implementing various embodiments as previously described. In various embodiments, the computing architecture 600 may comprise or be implemented as part of an electronic device. In some embodiments, computing architecture 600 may be representative, for example, of one or more portions of computing platform 102, such as power source 104, power converter 106, and/or encryption circuitry 108. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 604.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 994 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of computing platform 102, such as power converter 106.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 994 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

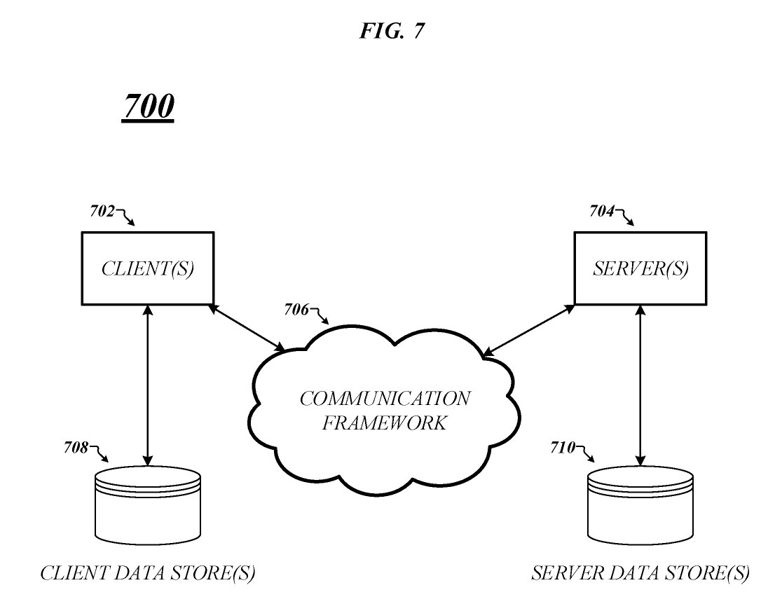

FIG. 7 illustrates a block diagram of an exemplary communications architecture 700 suitable for implementing various embodiments as previously described. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. The clients 702 and the servers 704 are operatively connected to one or more respective client data stores 708 and server data stores 710 that can be employed to store information local to the respective clients 702 and servers 704, such as cookies and/or associated contextual information. In various embodiments, any one of servers 704 may implement one or more of logic flows or operations described herein, and storage medium 500 of FIG. 5 in conjunction with storage of data received from any one of clients 702 on any of server data stores 710.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is a method for masking a power signature, the method comprising: charging or recharging a capacitor to an upper voltage with a power source of a computing platform; powering encryption circuitry with the capacitor to perform a first portion of an encryption operation for the computing platform; and recharging the capacitor to the upper voltage with the power source after completion of the first portion of the encryption operation.

Example 2 includes the subject matter of Example 1, comprising: charging or recharging a second capacitor to a second upper voltage with the power source when the capacitor powers the encryption circuitry to perform the first portion of the encryption operation; and powering the encryption circuitry with the second capacitor to perform a second portion of the encryption operation when the capacitor is recharged to the upper voltage with the power source.

Example 3 includes the subject matter of Example 2, comprising: powering the encryption circuitry with the capacitor to perform a third portion of the encryption operation; and recharging the second capacitor to the second upper voltage with the power source when the capacitor powers the encryption circuitry to perform the third portion of the encryption operation.

Example 4 includes the subject matter of Example 2, the first upper voltage equal to the second upper voltage.

Example 5 includes the subject matter of Example 1, comprising powering the encryption circuitry with the capacitor to perform a second portion of the encryption operation for the computing platform after the capacitor is recharged to the upper voltage with the power source.

Example 6 includes the subject matter of Example 5, comprising pausing the encryption operation when the capacitor is recharging to the upper voltage level with the power source.

Example 7 includes the subject matter of Example 1, comprising varying a voltage used to power the encryption circuitry.

Example 8 includes the subject matter of Example 1, comprising powering the encryption circuitry with the capacitor to perform the first portion of the encryption operation until the capacitor drops to a lower voltage.

Example 9 includes the subject matter of Example 8, comprising recharging the capacitor to the upper voltage in response to the capacitor dropping to the lower voltage.

Example 10 includes the subject matter of Example 1, the first portion of the encryption operation comprising a predefined number of encryption rounds.

Example 11 includes the subject matter of Example 10, comprising recharging the capacitor to the upper voltage in response to completion of the first portion of the encryption operation.

Example 12 includes the subject matter of Example 11, comprising causing the capacitor to drop to a lower voltage before recharging the capacitor to the upper voltage.

Example 13 includes the subject matter of Example 12, comprising dissipating power to ground to cause the capacitor to drop to the lower voltage.

Example 14 includes the subject matter of Example 1, comprising operating one or more switches to charge the capacitor with the power source.

Example 15 includes the subject matter of Example 1, comprising causing the power source to pass an electrical current through an inductor to the capacitor to charge the capacitor.

Example 16 includes the subject matter of Example 15, the inductor comprising magnetic shielding.

Example 17 includes the subject matter of Example 1, comprising operating one or more switches to power the encryption circuitry with the capacitor.

Example 18 includes the subject matter of Example 1, comprising causing the capacitor to pass an electrical current through an inductor to the encryption circuitry to power the encryption circuitry.

Example 19 includes the subject matter of Example 18, the inductor comprising magnetic shielding.

Example 20 includes the subject matter of Example 1, the power source comprising a power supply rail of the computing platform.

Example 21 includes the subject matter of Example 1, comprising a central processing unit (CPU) including a die, the capacitor disposed on the die.

Example 22 includes the subject matter of Example 1, the encryption operation comprising a plurality of rounds of encryption.

Example 23 includes the subject matter of Example 1, the encryption circuitry comprising an advanced encryption standard (AES) circuit.

Example 24 is an apparatus to mask a power signature, the apparatus comprising: a power converter to: charge or recharge a capacitor to an upper voltage with a power source of a computing platform; power encryption circuitry with the capacitor to perform a first portion of an encryption operation for the computing platform; and recharge the capacitor to the upper voltage with the power source after completion of the first portion of the encryption operation.

Example 25 includes the subject matter of Example 24, the power converter to: charge or recharge a second capacitor to a second upper voltage with the power source when the capacitor powers the encryption circuitry to perform the first portion of the encryption operation; and power the encryption circuitry with the second capacitor to perform a second portion of the encryption operation when the capacitor is recharged to the upper voltage with the power source.

Example 26 includes the subject matter of Example 25, the power converter to: power the encryption circuitry with the capacitor to perform a third portion of the encryption operation; and recharge the second capacitor to the second upper voltage with the power source when the capacitor powers the encryption circuitry to perform the third portion of the encryption operation.

Example 27 includes the subject matter of Example 25, the first upper voltage equal to the second upper voltage.

Example 28 includes the subject matter of Example 24, the power converter to power the encryption circuitry with the capacitor to perform a second portion of the encryption operation for the computing platform after the capacitor is recharged to the upper voltage with the power source.

Example 29 includes the subject matter of Example 28, the power converter to pause the encryption operation when the capacitor is recharged to the upper voltage level with the power source.

Example 30 includes the subject matter of Example 24, the power converter to vary a voltage used to power the encryption circuitry.

Example 31 includes the subject matter of Example 24, the power converter to power the encryption circuitry with the capacitor to perform the first portion of the encryption operation until the capacitor drops to a lower voltage.

Example 32 includes the subject matter of Example 31, the power converter to recharge the capacitor to the upper voltage in response to the capacitor dropping to the lower voltage.

Example 33 includes the subject matter of Example 24, the first portion of the encryption operation comprising a predefined number of encryption rounds.

Example 34 includes the subject matter of Example 33, the power converter to recharge the capacitor to the upper voltage in response to completion of the first portion of the encryption operation.

Example 35 includes the subject matter of Example 34, the power converter to cause the capacitor to drop to a lower voltage before recharging the capacitor to the upper voltage.

Example 36 includes the subject matter of Example 35, the capacitor to dissipate power to ground to cause the capacitor to drop to the lower voltage.

Example 37 includes the subject matter of Example 24, the power converter to operate one or more switches to charge the capacitor with the power source.

Example 38 includes the subject matter of Example 24, the power converter to cause the power source to pass an electrical current through an inductor to the capacitor to charge the capacitor.

Example 39 includes the subject matter of Example 38, the inductor comprising magnetic shielding.

Example 40 includes the subject matter of Example 24, the power converter to operate one or more switches to power the encryption circuitry with the capacitor.

Example 41 includes the subject matter of Example 24, the power converter to cause the capacitor to pass an electrical current through an inductor to the encryption circuitry to power the encryption circuitry.

Example 42 includes the subject matter of Example 41, the inductor comprising magnetic shielding.

Example 43 includes the subject matter of Example 24, the power source comprising a power supply rail of the computing platform.

Example 44 includes the subject matter of Example 24, comprising a central processing unit (CPU) including a die, the capacitor disposed on the die.

Example 45 includes the subject matter of Example 24, the encryption operation comprising a plurality of rounds of encryption.

Example 46 includes the subject matter of Example 24, the encryption circuitry comprising an advanced encryption standard (AES) circuit.

Example 47 is at least one non-transitory computer-readable medium comprising a set of instructions that, in response to being executed at a computing device, cause the computing device to: charge or recharge a capacitor to an upper voltage with a power source of a computing platform; power encryption circuitry with the capacitor to perform a first portion of an encryption operation for the computing platform; and recharge the capacitor to the upper voltage with the power source after completion of the first portion of the encryption operation.

Example 48 includes the subject matter of Example 47, comprising instructions that, in response to being executed at the computing device, cause the computing device to: charge or recharge a second capacitor to a second upper voltage with the power source when the capacitor powers the encryption circuitry to perform the first portion of the encryption operation; and power the encryption circuitry with the second capacitor to perform a second portion of the encryption operation when the capacitor is recharged to the upper voltage with the power source.

Example 49 includes the subject matter of Example 48, comprising instructions that, in response to being executed at the computing device, cause the computing device to: power the encryption circuitry with the capacitor to perform a third portion of the encryption operation; and recharge the second capacitor to the second upper voltage with the power source when the capacitor powers the encryption circuitry to perform the third portion of the encryption operation.

Example 50 includes the subject matter of Example 48, the first upper voltage equal to the second upper voltage.

Example 51 includes the subject matter of Example 47, comprising instructions that, in response to being executed at the computing device, cause the computing device to power the encryption circuitry with the capacitor to perform a second portion of the encryption operation for the computing platform after the capacitor is recharged to the upper voltage with the power source.

Example 52 includes the subject matter of Example 51, comprising instructions that, in response to being executed at the computing device, cause the computing device to pause the encryption operation when the capacitor is recharged to the upper voltage level with the power source.

Example 53 includes the subject matter of Example 47, comprising instructions that, in response to being executed at the computing device, cause the computing device to vary a voltage used to power the encryption circuitry.

Example 54 includes the subject matter of Example 47, comprising instructions that, in response to being executed at the computing device, cause the computing device to power the encryption circuitry with the capacitor to perform the first portion of the encryption operation until the capacitor drops to a lower voltage.

Example 55 includes the subject matter of Example 54, comprising instructions that, in response to being executed at the computing device, cause the computing device to recharge the capacitor to the upper voltage in response to the capacitor dropping to the lower voltage.

Example 56 includes the subject matter of Example 47, the first portion of the encryption operation comprising a predefined number of encryption rounds.

Example 57 includes the subject matter of Example 56, comprising instructions that, in response to being executed at the computing device, cause the computing device to recharge the capacitor to the upper voltage in response to completion of the first portion of the encryption operation.

Example 58 includes the subject matter of Example 57, comprising instructions that, in response to being executed at the computing device, cause the computing device to cause the capacitor to drop to a lower voltage before recharging the capacitor to the upper voltage.

Example 59 includes the subject matter of Example 58, the capacitor to dissipate power to ground to cause the capacitor to drop to the lower voltage.

Example 60 includes the subject matter of Example 47, comprising instructions that, in response to being executed at the computing device, cause the computing device to operate one or more switches to charge the capacitor with the power source.

Example 61 includes the subject matter of Example 47, comprising instructions that, in response to being executed at the computing device, cause the computing device to cause the power source to pass an electrical current through an inductor to the capacitor to charge the capacitor.

Example 62 includes the subject matter of Example 61, the inductor comprising magnetic shielding.

Example 63 includes the subject matter of Example 47, comprising instructions that, in response to being executed at the computing device, cause the computing device to operate one or more switches to power the encryption circuitry with the capacitor.

Example 64 includes the subject matter of Example 47, comprising instructions that, in response to being executed at the computing device, cause the computing device to cause the capacitor to pass an electrical current through an inductor to the encryption circuitry to power the encryption circuitry.

Example 65 includes the subject matter of Example 64, the inductor comprising magnetic shielding.

Example 66 includes the subject matter of Example 47, the power source comprising a power supply rail of the computing platform.

Example 67 includes the subject matter of Example 47, comprising a central processing unit (CPU) including a die, the capacitor disposed on the die.

Example 68 includes the subject matter of Example 47, the encryption operation comprising a plurality of rounds of encryption.

Example 69 includes the subject matter of Example 47, the encryption circuitry comprising an advanced encryption standard (AES) circuit.

Example 70 is an apparatus to mask a power signature, the apparatus comprising: means for charging or recharging a capacitor to an upper voltage with a power source of a computing platform; means for powering encryption circuitry with the capacitor to perform a first portion of an encryption operation for the computing platform; and means for recharging the capacitor to the upper voltage with the power source after completion of the first portion of the encryption operation.

Example 71 includes the subject matter of Example 70, comprising: means for charging or recharging a second capacitor to a second upper voltage with the power source when the capacitor powers the encryption circuitry to perform the first portion of the encryption operation; and means for powering the encryption circuitry with the second capacitor to perform a second portion of the encryption operation when the capacitor is recharged to the upper voltage with the power source.

Example 72 includes the subject matter of Example 71, comprising: means for powering the encryption circuitry with the capacitor to perform a third portion of the encryption operation; and means for recharging the second capacitor to the second upper voltage with the power source when the capacitor powers the encryption circuitry to perform the third portion of the encryption operation.

Example 73 includes the subject matter of Example 71, the first upper voltage equal to the second upper voltage.

Example 74 includes the subject matter of Example 70, comprising means for powering the encryption circuitry with the capacitor to perform a second portion of the encryption operation for the computing platform after the capacitor is recharged to the upper voltage with the power source.

Example 75 includes the subject matter of Example 74, comprising means for pausing the encryption operation when the capacitor is recharged to the upper voltage level with the power source.

Example 76 includes the subject matter of Example 70, comprising means for varying a voltage used to power the encryption circuitry.

Example 77 includes the subject matter of Example 70, comprising means for powering the encryption circuitry with the capacitor to perform the first portion of the encryption operation until the capacitor drops to a lower voltage.

Example 78 includes the subject matter of Example 77, comprising means for recharging the capacitor to the upper voltage in response to the capacitor dropping to the lower voltage.

Example 79 includes the subject matter of Example 70, the first portion of the encryption operation comprising a predefined number of encryption rounds.

Example 80 includes the subject matter of Example 79, comprising means for recharging the capacitor to the upper voltage in response to completion of the first portion of the encryption operation.

Example 81 includes the subject matter of Example 80, comprising means for causing the capacitor to drop to a lower voltage before recharging the capacitor to the upper voltage.

Example 82 includes the subject matter of Example 81, the capacitor to dissipate power to ground to cause the capacitor to drop to the lower voltage.

Example 83 includes the subject matter of Example 70, comprising means for operating one or more switches to charge the capacitor with the power source.

Example 84 includes the subject matter of Example 70, comprising means for causing the power source to pass an electrical current through an inductor to the capacitor to charge the capacitor.

Example 85 includes the subject matter of Example 84, the inductor comprising magnetic shielding.

Example 86 includes the subject matter of Example 70, comprising means for operating one or more switches to power the encryption circuitry with the capacitor.

Example 87 includes the subject matter of Example 70, comprising means for causing the capacitor to pass an electrical current through an inductor to the encryption circuitry to power the encryption circuitry.

Example 88 includes the subject matter of Example 87, the inductor comprising magnetic shielding.

Example 89 includes the subject matter of Example 70, the power source comprising a power supply rail of the computing platform.

Example 90 includes the subject matter of Example 70, comprising a central processing unit (CPU) including a die, the capacitor disposed on the die.

Example 91 includes the subject matter of Example 70, the encryption operation comprising a plurality of rounds of encryption.

Example 92 includes the subject matter of Example 70, the encryption circuitry comprising an advanced encryption standard (AES) circuit.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A method, comprising:
charging or recharging a capacitor to an upper voltage with a power source of a computing platform;
powering encryption circuitry with the capacitor to perform a first portion of an encryption operation for the computing platform; and
recharging the capacitor to the upper voltage with the power source after completion of the first portion of the encryption operation.

2. The method of claim 1, comprising:
charging or recharging a second capacitor to a second upper voltage with the power source when the capacitor powers the encryption circuitry to perform the first portion of the encryption operation; and
powering the encryption circuitry with the second capacitor to perform a second portion of the encryption operation when the capacitor is recharged to the upper voltage with the power source.

3. The method of claim 2, comprising:
powering the encryption circuitry with the capacitor to perform a third portion of the encryption operation; and
recharging the second capacitor to the second upper voltage with the power source when the capacitor powers the encryption circuitry to perform the third portion of the encryption operation.

4. The method of claim 2, the first upper voltage equal to the second upper voltage.

5. The method of claim 1, comprising powering the encryption circuitry with the capacitor to perform a second portion of the encryption operation for the computing platform after the capacitor is recharged to the upper voltage with the power source.

6. The method of claim 5, comprising pausing the encryption operation when the capacitor is recharging to the upper voltage level with the power source.

7. The method of claim 1, comprising varying a voltage used to power the encryption circuitry.

8. The method of claim 1, comprising powering the encryption circuitry with the capacitor to perform the first portion of the encryption operation until the capacitor drops to a lower voltage.

9. The method of claim 8, comprising recharging the capacitor to the upper voltage in response to the capacitor dropping to the lower voltage.

10. The method of claim 1, the first portion of the encryption operation comprising a predefined number of encryption rounds.

11. The method of claim 10, comprising recharging the capacitor to the upper voltage in response to completion of the first portion of the encryption operation.

12. The method of claim 11, comprising causing the capacitor to drop to a lower voltage before recharging the capacitor to the upper voltage.

13. The method of claim 12, comprising dissipating power to ground to cause the capacitor to drop to the lower voltage.

14. The method of claim 1, comprising operating one or more switches to charge the capacitor with the power source.

15. The method of claim 1, comprising causing the power source to pass an electrical current through an inductor to the capacitor to charge the capacitor.

16. The method of claim 1, comprising operating one or more switches to power the encryption circuitry with the capacitor.

17. The method of claim 1, comprising causing the capacitor to pass an electrical current through an inductor to the encryption circuitry to power the encryption circuitry.

18. An apparatus, comprising:
a power converter to:
charge or recharge a capacitor to an upper voltage with a power source of a computing platform;
power encryption circuitry with the capacitor to perform a first portion of an encryption operation for the computing platform; and
recharge the capacitor to the upper voltage with the power source after completion of the first portion of the encryption operation.

19. The apparatus of claim 18, the power converter to:
charge or recharge a second capacitor to a second upper voltage with the power source when the capacitor powers the encryption circuitry to perform the first portion of the encryption operation; and
power the encryption circuitry with the second capacitor to perform a second portion of the encryption operation when the capacitor is recharged to the upper voltage with the power source.

20. The apparatus of claim 18, the power converter to cause the capacitor to pass an electrical current through an inductor to the encryption circuitry to power the encryption circuitry.

21. The apparatus of claim 20, the inductor comprising magnetic shielding.

22. The apparatus of claim 18, the power source comprising a power supply rail of the computing platform.

23. The apparatus of claim 18, comprising a central processing unit (CPU) including a die, the capacitor disposed on the die.

24. The apparatus of claim 18, the encryption operation comprising a plurality of rounds of encryption.

25. The apparatus of claim 18, the encryption circuitry comprising an advanced encryption standard (AES) circuit.
